(19) United States
(12) Patent Application Publication
(10) Pub. No.: US 2011/0294460 A1
(43) Pub. Date: Dec. 1, 2011

(54) Wireless Gateway, System and Method for Automatic Call-For-Help

(75) Inventors: Jiangbin Zhu, Beijing (CN); Qiang Gao, Beijing (CN)

(73) Assignee: IVT SOFTWARE TECHNOLOGY INC., Beijing (CN)

(21) Appl. No.: 13/144,508

(22) PCT Filed: Jan. 15, 2010
(86) PCT No.: PCT/CN2010/000070

§ 371 Date: Aug. 11, 2011

(30) Foreign Application Priority Data
Jan. 15, 2009 (CN) 200910076964.3

(51) Int. Cl. H04W 4/22; H04M 11/04

(52) U.S. Cl. 455/404.1

(57) ABSTRACT

A wireless gateway, a system and a method supporting automatic call-for-help includes a wireless gateway which connects to a fixed line such as a fixed telephone. When a medical monitoring equipment detects an abnormal state of a patient, it notifies the wireless gateway. The wireless gateway then automatically dials the preset telephone number such as the number of an emergency center via the connected fixed line, or a mobile telephone in a short-range wireless connection to the wireless gateway automatically dials the number. Using the wireless gateway connected to a fixed telephone as location means solves the problem that existing location measures, like GPS, require high maintenance cost and cannot be used within buildings. In addition, the location information of a fixed telephone is accurate, which makes the present invention suitable for patient at home and in specific situations.

### TECHNICAL FIELD

The present invention relates to short-range wireless communication technology, in particular to a system and method for giving an emergency alert or making a call-for-help via a wireless gateway when a medical monitoring equipment detects an abnormal state of a patient.

### BACKGROUND ART

Due to greater living pressure and the change of human living habit, more and more empty-nest families arise where the elders do not live together with their children. When the elders in the empty-nest family suffer a sudden illness, the best treatment opportunity are very possible missed because no one around. Especially for the elders having heart disease, the sudden illness is mostly accompanied by such symptoms as dottiness and incompetence. In many cases the patients themselves are unable to finish a series of rescue measures like making a call-for-help.

When a monitoring device makes an automatic call-for-help, it becomes extremely important that this device can send an exact address of the patient accurately. However, at present most of the universal automatic call-for-help systems adopt location measures like GPS, which requires a high maintenance cost and cannot be used in buildings. All these limit the rapidly locating for the patients seriously.

Bluetooth technology achieves a rapid development in recent years and already becomes a part of human life. A Bluetooth gateway (also called as PSTN AP, Public Switched Telephone Network Access Point) can provide the merging function of a fixed telephone network and a mobile network.

A Bluetooth gateway connected to a fixed telephone is able to have the Bluetooth mobile telephone users automatically connected to the PSTN AP via Bluetooth technology within an open space of 100 meters around the Bluetooth gateway, such that the Bluetooth mobile telephone becomes a cordless telephone accessed via the Bluetooth gateway and is able to automatically switch between the mobile network like GSM/CDMA and the fixed telephone network. This means the users can enjoy the convenience with the Bluetooth mobile telephone with a small charge via the Bluetooth gateway.

### SUMMARY OF THE INVENTION

The technical problem to be solved by the present invention is: when making an automatic call-for-help with the aid of the existing communication network infrastructure, low precision of these location measures like GPS leads to the result that it is unable to rapidly find the caller thus wasting the good treatment opportunity. Therefore, the object of the present invention is to provide a more accurate location for the automatic caller for help.

For most of the families, a fixed telephone already becomes a necessity. Since a fixed telephone is often set up at a relatively fixed location, there is no possibility to have a random large-range movement in normal cases. Therefore, the location of a wireless gateway, such as a Bluetooth gateway, connected to the fixed telephone is relatively fixed as well. As a result, using the position of a wireless gateway as a location measure can provide accurate location information.

Based on the above understanding, according to one aspect of the present invention, a wireless gateway for said automatic call-for-help is disclosed, comprising: a short-range wireless communication module for receiving an alert signal detecting an abnormal sate of a patient from a medical monitoring equipment; a storage module for storing voice or text information including call-for-help telephone number and content; and a managing module for dialing the call-for-help telephone number stored in the storage module via the connected fixed line and sending the call-for-help content via the voice or text information when the short-range wireless communication module receives the alert signal.

Preferably, said call-for-help content includes an address where said wireless gateway is present, the address can be specific to the house number, for example, “Room 507, Zhongguancun Development Plaza, 12 Information Road, Shangdi, Haidian District, Beijing”. The address of said wireless gateway may be stored in a wireless device having a fixed position, said wireless gateway receives the address of said wireless gateway from said wireless device and stores it via the short-range wireless connection. Alternatively, the address where said wireless gateway is present may also be input into the mobile telephone by the user, said wireless gateway receives the address of said wireless gateway from this mobile telephone and stores it via the short-range wireless connection.

Preferably, once detecting that there is a mobile telephone in a short-range wireless connection to the wireless gateway, the wireless gateway further sends the call-for-help content via the voice or text information to said call-for-help telephone via said mobile telephone.

The other aspect of the invention discloses a system supporting automatic call-for-help, comprising: a medical monitoring equipment for detecting the state of the patient's illness and sending an alert signal to the wireless gateway while detecting an abnormal state; and a wireless gateway for dialing the preset call-for-help telephone number via the connected fixed line when it receives an alert signal of the medical monitoring equipment via the short-range wireless connection, and sending the preset call-for-help content via the voice or text information. Said call-for-help content includes an address of the wireless gateway, which can be specific to the house number.

Preferably, the system supporting automatic call-for-help may further comprise a mobile telephone. Once detecting that there is a mobile telephone in a short-range wireless connection to the wireless gateway, the wireless gateway further sends the call-for-help content via the voice or text information to the call-for-help telephone via said mobile telephone.

The present invention further proposes a method supporting automatic call-for-help, comprising the steps of:

(1) a medical monitoring equipment detecting the state of the patient's illness and sending an alert signal to the wireless gateway while detecting an abnormal state;
(2) a wireless gateway dialing the preset call-for-help telephone number via the connected fixed line when it receives an alert signal of the medical monitoring equipment via the short-range wireless connection, and sending the preset call-for-help content via the voice or text information, wherein said call-for-help content includes an address of the wireless gateway.

If the wireless gateway detects that there is a mobile telephone in a short-range wireless connection to it, a further step is included: the wireless gateway sending the call-for-help content via the voice or text information to the call-for-help telephone via said mobile telephone.

A wireless gateway is usually used in a fixed place, especially at home. The call-for-help content including an address of the wireless gateway and the call-for-help telephone number are stored in the wireless gateway, when the abnormal state of a patient is detected by the medical monitoring equipment and the patient is near to the wireless gateway, this wireless gateway is able to get an alert of the medical monitoring equipment via the short-range wireless connection in time and send out the call-for-help content to the call-for-help telephone via the fixed line of the fixed telephone, such that the patient can obtain timely assistance and help. Furthermore, since the position of the fixed line connected to the wireless gateway is fixed, the position of the wireless gateway is relatively fixed as well. Thereby, the position information obtained via, for example, a fixed telephone number, or the call-for-help address and information sent by the wireless gateway are also accurate, therefore, the medical staff can accurately locate the position of the related patient as long as the medical monitoring equipment gives an alert within its Bluetooth radio range.

If there is a mobile telephone in connection with the wireless gateway, or the medical monitoring equipment itself is a mobile telephone, the wireless gateway will further make a call-for-help via the mobile telephone so as to increase times of sending the call-for-help signal and guarantee a final success.

### DESCRIPTION OF DRAWINGS

In virtue of preferable embodiments, the process of the invention is explained in detail with reference to the drawings, this will facilitate better understanding of the object and advantages of the invention, wherein:

FIG. 1 is a block diagram illustrating the system supporting automatic call-for-help according to the preferable embodiments of the invention;

FIG. 2 is a block diagram illustrating the Bluetooth gateway as shown in FIG. 1 according to the preferable embodiments of the invention;

FIG. 3 is a flow chart illustrating the method for automatic call-for-help provided by the Bluetooth gateway as shown in FIG. 1 according to the preferable embodiments of the invention.

### SPECIFIC EMBODIMENTS

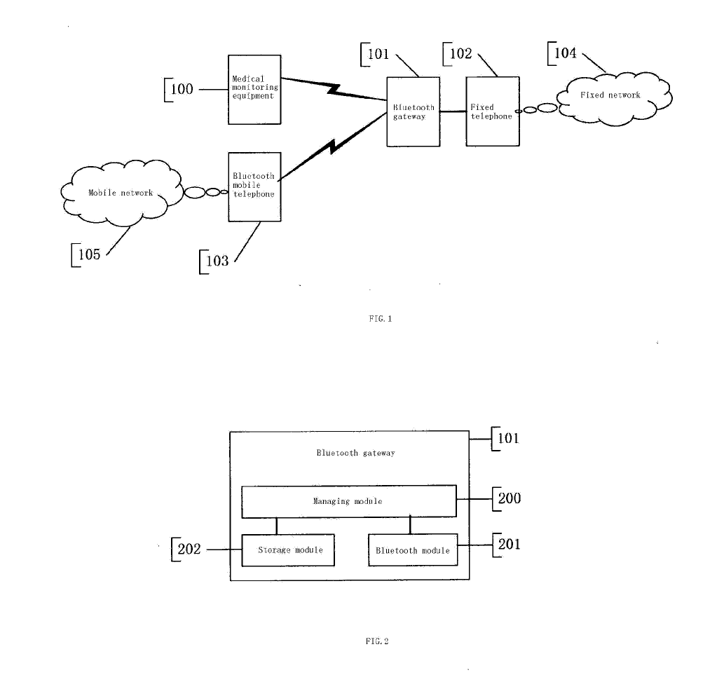

FIG. 1 is a block diagram illustrating the system supporting automatic call-for-help according to the preferable embodiments of the invention. The disclosure of this embodiment will focus on the technical aspects relating to the present invention, whereas other functions necessary for the operation of the equipment may be conventional. Although this embodiment is described in the context of Bluetooth communication, the present invention does not plan to be limited to this, instead it can be applied to other short-range wireless communication systems.

As shown in FIG. 1, the system comprises a medical monitoring equipment 100, a Bluetooth gateway 101 and a fixed telephone 102. Said medical monitoring equipment 100 is attached to the body of a patient for monitoring, alternatively, an index of abnormal state is pre-defined in said medical monitoring equipment 100 so as to make said medical monitoring equipment 100 give an alert once detecting the abnormal state. Medical monitoring equipment 100 of the present invention is not limited to cardiac detection and may be further expanded to the medical monitoring of other types, such as blood pressure and blood sugar level. Moreover, the range of monitoring is not limited to known diseases, said medical monitoring equipment 100 can also be used to provide an early warning of potential illnesses. In a preferable embodiment, medical monitoring equipment 100 is a hand-held mobile equipment, for example, a Bluetooth mobile telephone has the function of medical monitoring, that is, in FIG. 1, Bluetooth mobile telephone 102 and medical monitoring equipment 100 are merged into one hand-held mobile equipment.

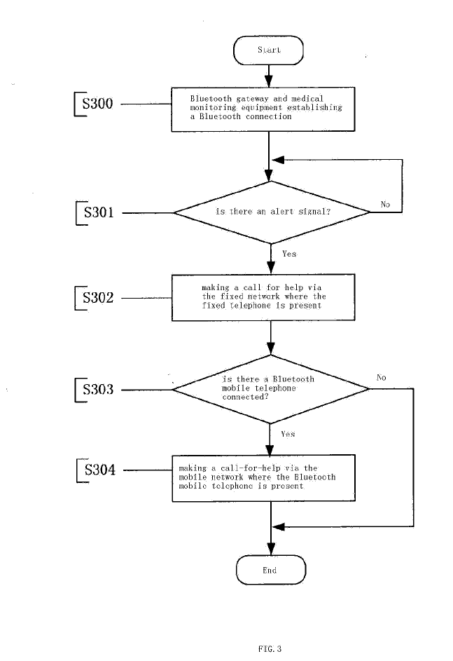

Bluetooth gateway 101 (as shown in FIG. 2) comprises a Bluetooth module 201, storage module 202 and managing module 200. It needs to explain that the details of known components and features are omitted for clearer presentation. Bluetooth gateway 101 establishes a Bluetooth connection to medical monitoring equipment 100 via Bluetooth module 201, in the meanwhile, Bluetooth gateway 101 is in a wired connection to fixed telephone 102.

The voice or text information including one or more call-for-help telephone numbers and related call-for-help content are stored in storage module 202. The call-for-help telephone may be set as the telephone numbers of emergency center “120” or other service centers, or the telephone numbers of friends and family. The call-for-help content includes the address of Bluetooth gateway 101, for example, the call-for-help content is a sound record prepared in advance: “I have a sudden heart attack and need emergency medical service, my address is Room 507, Zhongguancun Development Plaza, 12 Information Road, Shangdi, Haidian District, Beijing”, and a piece of text information containing the same content is stored additionally. Storage module 102 may be selected as a Random Access Memory (RAM) or Read Only Memory (ROM).

When detecting an abnormal state of the patient, medical monitoring equipment 100 sends an alert signal to Bluetooth module 201 of Bluetooth gateway 101 via a Bluetooth connection, or medical monitoring equipment 100 sends an alert signal to Bluetooth mobile telephone 103 via a Bluetooth connection, and then Bluetooth mobile telephone 103 sends the alert signal to Bluetooth module 201 of Bluetooth gateway 101. Managing module 200 of Bluetooth gateway 101 identifies this alert signal, reads the call-for-help telephone number and content from storage module 202, and dials the call-for-help telephone number via fixed network 104 where the connected fixed telephone 102 is present. When the call-for-help telephone is replied, managing module 200 sends the voice information of call-for-help content in the conversation. If fixed telephone 102 and call-for-help telephone support the transmission of text information as well, the fixed telephone further sends the text information of said call-for-help content to the call-for-help telephone. When storage module 202 contains a plurality of call-for-help telephone numbers, managing module 200 will continue dialing the next call-for-help telephone number after hanging up one call-for-help telephone, and send the call-for-help content to said next call-for-help telephone, till all call-for-help telephones are dialed.

Preferably, Bluetooth gateway 101 inquires whether there is a Bluetooth mobile telephone connected to it, for example, an inquiry is made according to the name of Bluetooth equipment. If Bluetooth gateway 101 finds that there is a Bluetooth mobile telephone 103 having an established Bluetooth connection to it, Bluetooth gateway 101 sends, via a Bluetooth connection, the call-for-help telephone number and content and the related signaling to Bluetooth mobile telephone 103, so as to make Bluetooth mobile telephone 103 dial a call-for-help telephone number via mobile network 105 and send the voice information of the call-for-help content, or send the text information of the call-for-help content to the call-for-help telephone in a manner of short message. The signaling transmitted between Bluetooth gateway 101 and Bluetooth mobile telephone 103 is, for example, an AT instruction, etc. This avoids the delay possibly caused by fixed network 104 and further ensure the success of emergency call.

Preferably, the call-for-help content in storage module 202 of Bluetooth gateway 101 includes the address where Bluetooth gateway 101 is present, for example, “Room 507, Zhongguancun Development Plaza, 12 Information Road, Shangdi, Haidian District, Beijing”. The address of said Bluetooth gateway 101 may be input by the user through Bluetooth mobile telephone 103, then sent from Bluetooth mobile telephone 103 to Bluetooth module 201 of Bluetooth gateway 101 via Bluetooth connection and stored in storage module 202. Alternatively, a Bluetooth equipment having a fixed position can be placed in a short-distance range of said Bluetooth gateway 101, said Bluetooth equipment stores the address of said Bluetooth gateway 101, for example, “Room 507, Zhongguancun Development Plaza, 12 Information Road, Shangdi, Haidian District, Beijing”, said Bluetooth gateway 101 acquires the address in said Bluetooth equipment through Bluetooth module 201 via a Bluetooth connection and stores it in storage module 202. In this way, the position information associated with Bluetooth gateway may be set flexibly, therefore, position update can be provided timely when the position of Bluetooth gateway has a change, for example, when it is placed in a new location.

FIG. 3 is a flow chart illustrating the method for automatic call-for-help provided by the Bluetooth gateway as shown in FIG. 1 according to the preferable embodiments of the invention.

Bluetooth gateway 101 establishes a Bluetooth connection S300 with medical monitoring equipment 100.

Bluetooth gateway 101 inquires whether there is alert signal sent by medical monitoring equipment 100 S301, if yes, Bluetooth gateway 101 gives a call for help through fixed network 104 where the connected fixed telephone 102 is present S302, that is, controlling fixed telephone 102 to dial the call-for-help telephone number stored in Bluetooth gateway 101, and transmitting to the call-for-help telephone the voice or text information of call-for-help content preset in Bluetooth gateway 101 in advance; otherwise, Bluetooth gateway 101 continues to inquire whether there is alert signal sent by medical monitoring equipment 100 S301.

After finishing emergency call-for-help through fixed telephone 102, Bluetooth gateway 101 continues to inquire whether there is a Bluetooth mobile telephone 103 having an established Bluetooth connection to it S303, if yes, a call for help is further sent via mobile network 105 where Bluetooth mobile telephone 103 is present S304, that is, Bluetooth gateway 101 sends the call-for-help telephone number and content and the related signaling via Bluetooth connection, so as to make Bluetooth mobile telephone 103 dial the call-for-help telephone number and send the voice information of call-for-help content, or make Bluetooth mobile telephone 103 send the text information of call-for-help content to the call-for-help telephone in a manner of short message. It comes to end if Bluetooth gateway 101 does not find a Bluetooth mobile telephone 103 having an established connection to it.

In the preferable embodiments of the invention, medical monitoring equipment 100 and Bluetooth gateway 101 are described as Bluetooth connection. Within the claimed range of the invention, however, other short-range wireless connections or wired connections may be established between medical monitoring equipment 100 and Bluetooth gateway 101. In addition, after Bluetooth 3.0 standard is launched, Bluetooth module 201 will include other short-range wireless communication technology, such as WiFi, therefore, medical monitoring equipment 100 and Bluetooth gateway 101 can communicate with each other using other short-range wireless technology like WiFi in Bluetooth module 201 as well, and consequently, Bluetooth module 201 can also be called as short-range wireless communication module, and Bluetooth gateway 101 can be called as wireless gateway as well.

In the preferable embodiments of the present invention, Bluetooth gateway 101 is described as connecting to the fixed telephone. Within the claimed range of the invention, however, Bluetooth gateway 101 can also be connected to Internet (IP) or other fixed lines such as Cable TV and power line, and dial the call-for-help telephone number via said fixed lines. The position of Bluetooth gateway 101 is relatively fixed, so the address as recorded is also accurate.

Although the present invention is illustrated and described with reference to its preferable embodiments, those ordinarily skilled in the art should understand that various changes in form and detail are allowable in the case of not deviating from spirit and scope of the invention defined in the appended Claims.

1. A wireless gateway supporting automatic call-for-help, comprising:
a short-range wireless communication module for receiving an alert signal detecting an abnormal state of a patient from a medical monitoring equipment;
a storage module for storing a voice or text information including a call-for-help telephone number and content; and
a managing module for dialing the call-for-help telephone number stored in the storage module via a connected fixed line and sending the call-for-help content via the voice or text information when the short-range wireless communication module receives the alert signal.

2. The wireless gateway as recited in claim 1, wherein:
when the wireless gateway detects that there is a mobile telephone in a short-range wireless connection to the wireless gateway, the wireless gateway further sends the call-for-help content via the voice or text information to the call-for-help telephone number via the mobile telephone.

3. The wireless gateway as recited in claim 1, wherein:
the call-for-help content includes an address where the wireless gateway is present.

4. The wireless gateway as recited in claim 3, wherein:
the address where the wireless gateway is present is stored in a wireless device having a fixed position, the wireless gateway receives the address of the wireless gateway from the wireless device and stores the address of the wireless gateway via the short-range wireless connection.

5. The wireless gateway as recited in claim 16, wherein:
the address where the wireless gateway is present is input into the mobile telephone by a user, the wireless gateway receives the address of the wireless gateway from the mobile telephone and stores the address of the wireless gateway via the short-range wireless connection.

6. A system supporting automatic call-for-help, comprising:
a medical monitoring equipment for detecting a state of a patient's illness and sending an alert signal to a wireless gateway while detecting an abnormal state; and
a wireless gateway for dialing a preset call-for-help telephone number via a connected fixed line when the wireless gateway receives the alert signal of the medical monitoring equipment via a short-range wireless connection, and sending a preset call-for-help content via a voice or text information.

7. The system as recited in claim 6, further comprising a mobile telephone, wherein when the wireless gateway detects that the mobile telephone is in a short-range wireless connection to the wireless gateway, the wireless gateway sends the call-for-help content via the voice or text information to the call-for-help telephone number via the mobile telephone.

8. The system as recited in claim 6, wherein:
the call-for-help content includes an address where the wireless gateway is present.

9. The system as recited in claim 8, further comprising a wireless device having a fixed position for storing the address where the wireless gateway is present, the wireless gateway receives the address of the wireless gateway from the wireless device and stores the address of the wireless gateway via the short-range wireless connection.

10. The system as recited in claim 17, wherein:
the address where the wireless gateway is present is input into the mobile telephone by a user, the wireless gateway receives the address of the wireless gateway from the mobile telephone and stores the address of the wireless gateway via the short-range wireless connection.

11. A method supporting automatic call-for-help, comprising the steps of:
detecting, by a medical monitoring equipment, a state of a patient's illness and sending an alert signal to a wireless gateway while detecting an abnormal state; and
dialing, by the wireless gateway, a preset call-for-help telephone number via a connected fixed line when the wireless gateway receives the alert signal of the medical monitoring equipment via a short-range wireless connection, and sending a preset call-for-help content via a voice or text information.

12. The method as recited in claim 11, wherein:
when the wireless gateway detects that there is a mobile telephone in a short-range wireless connection to the wireless gateway, the wireless gateway further sends the call-for-help content via the voice or text information to the call-for-help telephone via the mobile telephone.

13. The method as recited in claim 11, wherein:
the call-for-help content includes an address where the wireless gateway is present.

14. The method as recited in claim 13, wherein:
the address where the wireless gateway is present is stored in a wireless device having a fixed position, the wireless gateway receives the address of the wireless gateway from the wireless device and stores the address of the wireless gateway via the short-range wireless connection.

15. The method as recited in claim 18, wherein:
the address where the wireless gateway is present is input into the mobile telephone by a user, the wireless gateway receives the address of the wireless gateway from this mobile telephone and stores the address of the wireless gateway via the short-range wireless connection.

16. The wireless gateway as recited in claim 2, wherein:
the call-for-help content includes an address where the wireless gateway is present.

17. The system as recited in claim 6, wherein:
the call-for-help content includes an address where the wireless gateway is present.

18. The method as recited in claim 12, wherein:
the call-for-help content includes an address where the wireless gateway is present.
